(19) United States
(12) Patent Application Publication
(10) Pub. No.: US 2026/0274011 A1
(43) Pub. Date: Sep. 17, 2026

(54) TECHNOLOGIES FOR DETERMINING TREAD WEAR OF TIRE OF A VEHICLE

(71) Applicant: CalAmp Corp., Carlsbad, CA (US)

(72) Inventors: Christopher Adams, Carlsbad, CA (US); Robert Bradshaw, Carlsbad, CA (US)

(21) Appl. No.: 19/559,019

(22) Filed: Mar. 6, 2026

Related U.S. Application Data
(60) Provisional application No. 63/771,933, filed on Mar. 14, 2025.

(51) Int. Cl. B60C 11/24; B60C 23/06

(52) U.S. Cl. CPC B60C 11/246; B60C 11/243; B60C 23/061

(57) ABSTRACT

Technologies for determining tread wear of a tire of a vehicle include a telematics system having a one or more tire revolutions-per-minute (RPM) sensors and a telematics gateway. Each tire RPM sensor is coupled to a corresponding wheel of the vehicle and is configured to generate tire RPM data that is indicative of a number of rotations of the tire. The telematics gateway is configured to communicate with the tire RPM sensor to request the tire RPM data, determine a radius of the tire based on the tire RPM data, and determine an estimated amount of tire tread wear of the tire based on the determined radius of the tire. The RPM sensor may be embodied as, for example, an accelerometer, a gyroscope, a tire rotation count sensor, and/or the other sensor capable for generating tire RPM data indicative of a number of rotations of the tire.

The present application claims priority under 35 U.S.C. § 119 (e) to U.S. Provisional Patent Application No. 63/771,933, entitled “TECHNOLOGIES FOR DETERMINING TREAD WEAR OF TIRE OF A VEHICLE,” which was filed on Mar. 14, 2025, the entirety of which is incorporated herein by reference.

### FIELD OF THE DISCLOSURE

The present disclosure relates generally to telematics and associated telematics devices and, more particularly, to a telematics system for determining an amount of tread wear of a tire of a vehicle.

### BACKGROUND

Telematics involves the integrated use of telecommunications and informatics, particularly for application in vehicles and other assets. Telematics functionality may include, but is not limited to, recording vehicle information, emergency warning systems, crash prediction and detection, navigation functionality, safety warnings, fleet and asset management, and automated driving assistance. Vehicle telematics devices may process and transmit telematics data and other messages generated by a vehicle and connected devices. For example, the telematics data may be produced by sensors, controllers, and/or other peripheral devices located on the vehicle and/or within the telematics device itself.

Vehicle telematics devices may be used, for example, to monitor various operational characteristics of the vehicle and/or accessory (e.g., tires) of the vehicle. To do so, telematics devices typically monitor sensor data produced by associated sensors located on the vehicle or the vehicle accessory, such as a wheel of the vehicle. Under some conditions or situations, certain operational characteristics of the vehicle may be impossible or otherwise difficult to measure directly. Such operational characteristics, however, may be determined or estimated based on other sensed characteristics.

### SUMMARY

According to an aspect of the present disclosure, a telematics system for monitoring tire tread wear of a tire of a wheel of a vehicle may include a tire revolutions-per-minute (RPM) sensor and a telematics gateway. The tire RPM sensor may be coupled to the wheel of the vehicle and may be configured to generate tire RPM data that is indicative of a number of rotations of the tire. The telematics gateway may be configured to communicate with the tire RPM sensor to request the tire RPM data, determine a radius of the tire based on the tire RPM data, and determine an estimated amount of tire tread wear of the tire based on the determined radius of the tire. In some embodiments, to determine the estimated amount of tire tread wear of the tire based on the determined radius of the tire may include to compare the determined radius of the tire to a previously determined radius of the tire.

Additionally, in some embodiments, the tire RPM sensor may be embodied as an accelerometer sensor and the tire RPM data may be embodied as g-force sensor data indicative of an acceleration of the vehicle. In such embodiments, the accelerometer may be mounted on the wheel a mounting distance from a center of the wheel. Additionally, in such embodiments, to determine the radius of the tire based on the tire RPM data may include to determine the radius of the tire based on the g-force sensor data and the mounting distance. For example, to determine the radius of the tire based on the g-force sensor data and the mounting distance may include to determine a revolutions-per-minute (RPM) of the tire based on the g-force sensor data and the mounting distance. Additionally, in such embodiments, to determine the radius of the tire based on the tire RPM data may include to determine a distance traveled by the vehicle over a reference time period; determine an average RPM of the tire over the reference time period based on the g-force sensor data and the mounting distance; determine a tire circumference of the tire based on the distance traveled and the average RPM of the tire; and determine the radius of the tire based on the determined tire circumference.

In some embodiments, the tire RPM sensor may be embodied as a rotation count sensor and the tire RPM data may be embodied as rotation count sensor data indicative of a number of rotations of the tire over a reference time period. In such embodiments, to determine the radius of the tire based on the tire RPM data may include to determine a distance traveled by the vehicle over the reference time period; determine a tire circumference of the tire based on the distance traveled and the rotation count sensor data; and determine the radius of the tire based on the determined tire circumference.

Additionally, in some embodiments, the tire RPM sensor may be embodied as a gyroscope sensor and the tire RPM data may be embodied as angular velocity data indicative of a present angular velocity of the tire. In such embodiments, to determine the radius of the tire based on the tire RPM data may include to determine a present velocity of the vehicle; determine a tire circumference of the tire based on the present velocity and the angular velocity; and determine the radius of the tire based on the determined tire circumference.

According to another aspect of the present disclosure, a method for monitoring tire tread wear of a tire of a wheel of a vehicle may include communicating, by a telematics gateway, with a tire RPM sensor coupled to the tire of the wheel of the vehicle to request tire RPM data. The tire RPM data may be indicative of a number of rotations of the tire. The method may also include determining, by the telematics gateway, a radius of the tire based on the tire RPM data and determining, by the telematics gateway, an estimated amount of tire tread wear of the tire based on the determined radius of the tire. In some embodiments, determining the estimated amount of tire tread wear of the tire based on the determined radius of the tire may include comparing, by the telematics gateway, the determined radius of the tire to a previously determined radius of the tire.

Additionally, in some embodiments, communicating with the tire RPM sensor may include communicating, by the telematics gateway, with an accelerometer sensor mounted on the wheel a mounting distance from a center of the wheel to request g-force sensor data from the accelerometer. In such embodiments, determining the radius of the tire based on the tire RPM data may include determining, by the telematics gateway, a revolutions-per-minute (RPM) of the tire based on the g-force sensor data and the mounting distance. Additionally, in such embodiments, determining the radius of the tire based on the tire RPM data may include determining, by the telematics gateway, a distance traveled by the vehicle over a reference time period; determining, by the telematics gateway, an average RPM of the tire over the reference time period based on the g-force sensor data and the mounting distance; determining, by the telematics gateway, a tire circumference of the tire based on the distance traveled and the average RPM of the tire; and determining, by the telematics gateway, the radius of the tire based on the determined tire circumference.

Furthermore, in some embodiments, communicating with the tire RPM sensor may include communicating, by the telematics gateway, with a rotation count sensor to request rotation count sensor data indicative of a number of rotations of the tire over a reference time period. In such embodiments, determining the radius of the tire based on the tire RPM data may include determining, by the telematics gateway, a distance traveled by the vehicle over the reference time period; determining, by the telematics gateway, a tire circumference of the tire based on the distance traveled and the rotation count sensor data; and determining, by the telematics gateway, the radius of the tire based on the determined tire circumference.

Additionally, in some embodiments, communicating with the tire RPM sensor may include communicating, by the telematics gateway, with a gyroscope sensor to request angular velocity data indicative of a present angular velocity of the tire. In such embodiments, determining the radius of the tire based on the tire RPM data may include determining, by the telematics gateway, a present velocity of the vehicle; determining, by the telematics gateway, a tire circumference of the tire based on the present velocity and the angular velocity; and deter determining, by the telematics gateway, mine the radius of the tire based on the determined tire circumference.

According to a further aspect of the present disclosure, one or more non-transitory, computer-readable storage media comprising a plurality of instructions that in response to being executed cause a telematics gateway to communicate with a tire RPM sensor coupled to the tire of the wheel of the vehicle to request tire RPM data. The tire RPM data may be indicative of a number of rotations of the tire. The plurality of instructions, in response to execution, may further cause the telematics gateway to determine a circumference of the tire based on the tire RPM data; determine a radius of the tire based on the determined circumference of the tire; and determine an estimated amount of tire tread wear of the tire based on the determined radius of the tire.

In some embodiments, to determine the estimated amount of tire tread wear of the tire based on the determined radius of the tire may include to compare the determined radius of the tire to a previously determined radius of the tire.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for monitoring tire tread wear of a tire of a wheel of a vehicle including a telematics gateway and a set of tire revolutions-per-minute (RPM) sensors;

FIG. 2 is a simplified block diagram of at least one embodiment of a tire RPM sensor of the system of FIG. 1;

FIG. 3 is a simplified diagram of the system of FIG. 1 installed in a tractor trailer with each tire RPM sensor coupled to a wheel of a trailer of the tractor trailer;

FIG. 4 is a simplified flow diagram of at least one embodiment of a method for monitoring tire tread wear of a tire of a wheel of a vehicle, which may be executed by the telematics gateway of the system of FIG. 1;

FIG. 5 is a simplified flow diagram of at least one embodiment of a method for determining a tire circumference based on g-force sensor data received from an accelerometer sensor, which may be executed as the telematics gateway of the system of FIG. 1 during execution of the method of FIG. 4;

FIG. 6 is a simplified illustration of a wheel of the tractor trailer of FIG. 3 illustrating a mounting location of an accelerometer on the wheel for use with the method of FIG. 4;

FIG. 7 is a simplified flow diagram of at least one embodiment of a method for determining a tire circumference based on rotation count sensor data received from a rotation count sensor, which may be executed as the telematics gateway of the system of FIG. 1 during execution of the method of FIG. 4;

FIG. 8 is a simplified flow diagram of at least one embodiment of a method for determining a tire circumference based on angular velocity sensor data received from a gyroscope sensor, which may be executed as the telematics gateway of the system of FIG. 1 during execution of the method of FIG. 4; and

FIG. 9 is a simplified flow diagram of at least one embodiment of a method for determining tire RPM data that may be executed by each tire RPM sensor of the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

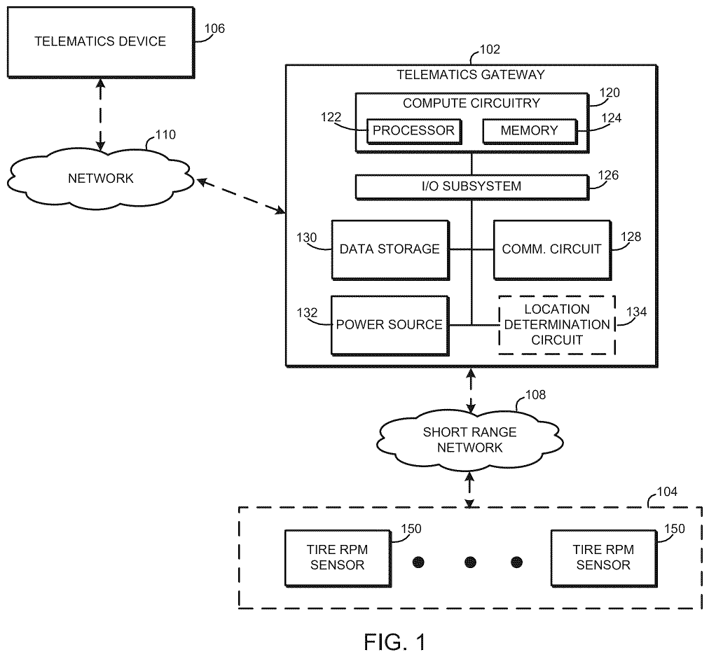

Referring now to FIG. 1, an illustrative telematics system 100 for monitoring tire pressure of a vehicle includes a telematics gateway 102, a set 104 of tire revolutions-per-minute (RPM) sensors 150, and a telematics device 106. The system 100 also includes a short range network 108 over which the telematics gateway 102 and the tire RPM sensors 150 communicate and a network 110 over which the telematics gateway 102 and the telematics device 106 communicate. In some embodiments, the network 110 may be embodied as the same network as the short range network 108.

In use, as discussed in more detail below, the telematics gateway 102 is configured to determine the tire tread wear of one or more tires of a vehicle based on tire revolutions-per-minute (RPM) sensor data received from the tire RPM sensors 150. To do so, the telematics gateway 102 communicates with each tire RPM sensor 150 to request the tire RPM data from the corresponding tire RPM sensor 150, determines a radius of the tire based on the tire RPM data, and determines an estimated amount of tire tread wear (or remaining tire tread) of the respective tire based on the determined radius of that tire. For example, the telematics gateway 102 may compare the determined radius of the tire to a previously determined radius to thereby determine an amount of tread wear of the respective tire. The tire RPM data may be embodied as any type of data that is indicative of a number of rotations of the tire (e.g., over a reference time period or distance). For example, as described below, the tire RPM data may be embodied as g-force sensor data indicative of an amount of acceleration of the tire and generated by a corresponding accelerometer, rotation count sensor data indicative of a number of rotation of the respective tire over a reference time period and generated by a rotation count sensor, angular velocity data indicative of a present angular velocity of the respective tire and generated by a gyroscope sensor, or other sensor data from which a present RPM of the respective tire can be determined.

The telematics gateway 102 may be embodied as any device or collection of devices capable of communicating with the tire RPM sensors 150 and the telematics device 106, determining an amount of tire tread wear of one or more tires of an associated vehicle using the methodology described herein, and performing the other functionality described below. In the illustrative embodiment, the telematics gateway 102 includes compute circuitry 120, an I/O subsystem 126, a data storage 130, a communication circuit 128, a power source 132, and, in some embodiments, a location determination circuit 134. Of course, the telematics gateway 102 may include other or additional components, such as those commonly found in a portable or embedded computer (e.g., various input/output devices), in other embodiments. Additionally, in some embodiments, one or more of the illustrative components may be incorporated in, or otherwise form a portion of, another component.

The compute circuitry 120 may be embodied as any type of device or collection of devices capable of performing various compute functions. In some embodiments, the compute circuitry 120 may be embodied as a single device such as an integrated circuit, an embedded system, a field-programmable-array (FPGA), a system-on-a-chip (SOC), or other integrated system or device. Additionally, in some embodiments, the compute circuitry 120 includes or is embodied as a processor 122 and memory 124. The processor 122 may be embodied as any type of processor capable of performing the functions described herein. For example, the processor 122 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the telematics gateway 102 such as operating systems, applications, programs, libraries, and drivers.

The compute circuitry 120 is communicatively coupled to other components of the telematics gateway 102 via the I/O subsystem 126, which may be embodied as circuitry and/or components to facilitate input/output operations with the compute circuitry 120 (e.g., with the processor 122 and/or memory 124) and other components of the telematics gateway 102. For example, the I/O subsystem 126 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The data storage device 130 may be embodied as any type of device or devices configured for short-term or long-term storage of data such as, for example, memory devices and circuits, memory cards, hard disk drives, solid-state drives, or other data storage devices. The data storage device 130 may store various data including programs, scripts, location data, message data, and other types of digital data. For example, in some embodiments, the telematics gateway 102 may be configured to store identification data of each tire RPM sensor 150, along with the reported tire RPM data as discussed in more detail below.

The communication circuit 128 of the telematics gateway 102 may be embodied as any type of communication circuit, device, or collection thereof, capable of enabling communications between the telematics gateway 102 and the tire RPM sensors 150 over the short range network 108 and between the telematics gateway 102 and the telematics device 106 over the network 110. To do so, the communication circuit 128 may utilize any suitable communication protocol. For example, the communication circuit 128 may be configured to use a short range communication protocol such as Bluetooth® Low Energy (BLE) protocol and associated technology to communicate with the tire RPM sensors 150 over the short range network 108. Additionally, the communication circuit 128 may be configured to use a long range communication protocol including, but not limited to Long-Term Evolution (LTE), 4G LTE, 5G, Wi-Fi (e.g., communications based on the Institute of Electrical and Electronics Engineers (IEEE) 802.11 family), Ethernet, Worldwide Interoperability for Microwave Access (WiMAX), Ethernet, Global System for Mobile Communications (GSM), and/or General Packet Radio Service (GPRS), to communicate with the telematics device 106 over the network 110. In some embodiments, the communication circuit 128 may utilize the same communication protocol to communicate with the tire RPM sensors 150 and the telematics device 106, such as a short range communication protocol (e.g., a Bluetooth® protocol). In such embodiments, the networks 108, 110 may be the same or similar networks.

The power source 132 may be embodied as any type of electrical power source capable of providing power to the other components of the telematics gateway 102. For example, the power source 132 may be embodied as a battery or similar independent power source. In some embodiments, the telematics gateway 102 may be configured to be wired to an external power source, such as the power source (e.g., battery) of the vehicle or trailer in which the telematics gateway 102 is installed. In such embodiments, the power source 132 may be embodied as or otherwise include a power connector or similar interconnect for interfacing with the external power source.

The location determination circuit 134 may be embodied as any type of circuit, device, or collection of devices configured to determine a present location of the telematics gateway 102. To do so, the location determination circuit 134 may use any suitable mechanism and/or data to determine the present location of the telematics gateway 102. For example, in some embodiments, the location determination circuit 134 may be embodied as or otherwise include a global positioning system (GPS) circuit configured to generate sensor data indicative of the present location of the telematics gateway 102 based on signals received from satellites of the GPS. In other embodiments, the location determination circuit 134 may be configured to determine or infer the present location of the telematics gateway 102 by trilateration or triangulation of communication signals, such as cellular signals from nearby cellular towers or Wi-Fi signals from nearby hotspots.

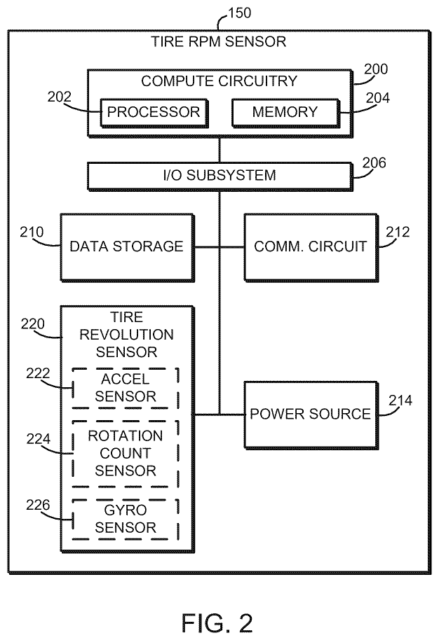

Referring now to FIG. 2, each tire RPM sensor 150 may be embodied as any electrical device capable of measuring or otherwise detecting an operational characteristic of an associated tire of a vehicle that is indicative of a number of rotations of the associated tire and communicating sensor data to the telematics gateway 102 as described below. In the illustrative embodiment, each tire RPM sensor 150 is configured to be secured to a rim or tire of the associated wheel to facilitate the measurement of the RPM sensor data of that tire.

In the illustrative embodiment, each tire RPM sensor 150 includes compute circuitry 200, an I/O subsystem 206, a data storage 210, a communication circuit 212, a power source 214, and a tire revolution sensor 220. Of course, the tire RPM sensor 150 may include other or additional components, such as those commonly found in an electronic sensor module, in other embodiments. Additionally, in some embodiments, one or more of the illustrative components may be incorporated in, or otherwise form a portion of, another component. For example, in the illustrative embodiment, each of the compute circuitry 200, the I/O subsystem 206, and the communication circuit 212 are grouped together in a wireless modem or radio module.

The compute circuitry 200 may be embodied as any type of device or collection of devices capable of performing various compute functions. In some embodiments, the compute circuitry 200 may be embodied as a single device such as an integrated circuit, an embedded system, a field-programmable-array (FPGA), a system-on-a-chip (SOC), or other integrated system or device. Additionally, in some embodiments, the compute circuitry 200 includes or is embodied as a processor 202 and memory 204. The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the tire RPM sensor 150 such as operating systems, applications, programs, libraries, and drivers.

The compute circuitry 200 is communicatively coupled to other components of the tire RPM sensor 150 via the I/O subsystem 206, which may be embodied as circuitry and/or components to facilitate input/output operations with the compute circuitry 200 (e.g., with the processor 202 and/or memory 204) and other components of the tire RPM sensor 150. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The data storage device 210 may be embodied as any type of device or devices configured for short-term or long-term storage of data such as, for example, memory devices and circuits, memory cards, hard disk drives, solid-state drives, or other data storage devices. The data storage device 210 may store various data including programs, scripts, location data, message data, and other types of digital data. For example, in some embodiments, the tire RPM sensor 150 may be configured to store identification data that uniquely identifies the tire RPM sensor 150 from other tire RPM sensor 150 and the tire RPM sensor data indicative of a number of rotation of the associated tire as discussed below.

The communication circuit 212 of the tire RPM sensor 150 may be embodied as any type of communication circuit, device, or collection thereof, configured for communication over a relative short distance, such as over a wireless personal area network (PAN). In doing so, the communication circuit 212 may utilize any suitable short range communication protocol. In the illustrative embodiment, the communication circuit 212 is embodied as a Bluetooth® communication device configured to use Bluetooth® Low Energy (BLE) protocol and associated technology to facilitate communications over the short range network 108.

The power source 216 may be embodied as any type of electrical power source capable of providing power to the other components of the tire RPM sensor 150. For example, the local power source 216 may be embodied as a battery or similar independent power source.

The tire revolution sensor 220 may be embodied as any type of sensor capable of measuring an operational characteristic of the associated tire and generating tire RPM sensor data that is indicative of a number of rotations of the associated tire. That is, the tire RPM sensor data may directly represent the number of rotations or may be embodied as sensor data from which the number of rotation can be determined. For example, in some embodiments, the tire revolution sensor 220 may be embodied as an accelerometer sensor 222 configured to generate g-force sensor data indicative of an acceleration of the associated tire. In other embodiments, the tire revolution sensor 220 may be embodied as a rotation count sensor 224 (e.g., a reed switch sensor) configured to directly measure or detect each rotation of the associated tire and generate rotation count sensor data indicative of a number of rotations of the associated tire over a reference time period. In still other embodiments, the tire revolution sensor 220 may be embodied as a gyroscope sensor 226 configured to generate angular velocity data indicative of a present angular velocity of the associated tire.

Referring now back to FIG. 1, the telematics device 106 may be embodied as any type of device or collection of devices capable of monitoring various characteristics of an associated vehicle (e.g., location, movement, operational characteristics, etc.) and communicating with the telematics gateway 102 and, in some embodiments, a remote server (not shown) such as a remote management server, fleet management computer, asset owner management server, a telematics server, a data analytics server, and/or other type of remote computer device or system. The telematics device 106 may include components commonly found in telematics devices such as compute circuitry, data storage, and communication circuits. In use, the telematics device 106 is configured to communicate with the telematics gateway 102 to receive tire tread wear data of each associated tire. The telematics device 106 may be configured to analyze the tire tread wear data locally and/or to transmit the tire tread wear data to the remove server (not shown). For example, in some embodiments, the telematics device 106 may be configured to generate reports based on the tire tread wear data and/or generate alerts to a driver of the associated vehicle based on the received tire tread wear data.

The short range network 108 may be embodied as any type of network capable of facilitating short range communications between the telematics gateway 102 and the tire RPM sensors 150. In the illustrative embodiment, the short range network 108 is embodied as an ad hoc, wireless personal area network (PAN) configured to support Bluetooth® Low Energy (BLE) communication protocols.

The network 110 may be embodied as any type of network capable of facilitating short range communications between the telematics gateway 102 and the telematics device 106. In some embodiments, the network 110 may be identical to the short range network 108 or even the same network. In other embodiments, the network 110 may be embodied as a long range network such as a cellular network, a publicly-accessible, global network such as the Internet, a wireless wide area network (WAN), and/or other network or other data communication infrastructure. In such embodiments, the network 110 may facilitate various data communication specifications and/or protocols including, but not limited to, Long-Term Evolution (LTE), 4G LTE, 5G, Wi-Fi (e.g., communications based on the Institute of Electrical and Electronics Engineers (IEEE) 802.11 family), Worldwide Interoperability for Microwave Access (WiMAX), Ethernet, Global System for Mobile Communications (GSM), and/or General Packet Radio Service (GPRS). As such, the network 110 may include any number of additional devices, such as additional computers, routers, stations, and switches, to facilitate such communications among the telematics device 106 and the telematics gateway 102.

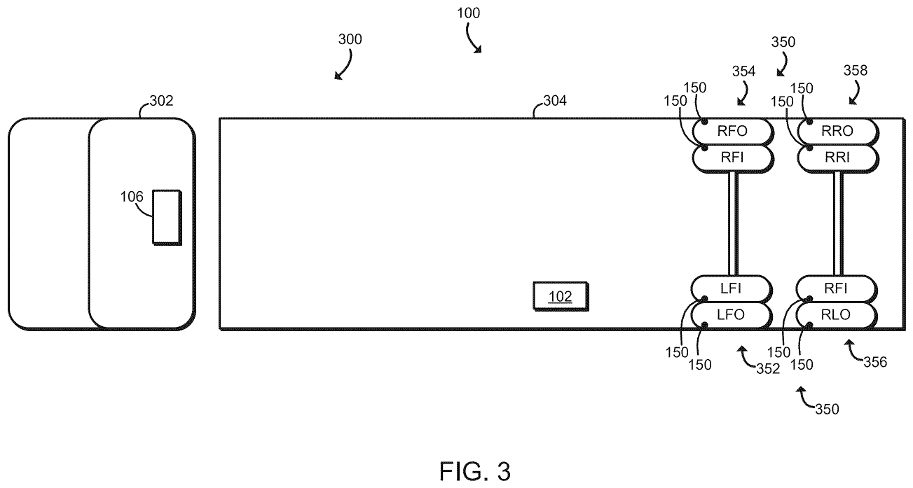

Referring now to FIG. 3, in use, the system 100 is configured to be installed into a vehicle 300 such as a tractor trailer having multiple tire pairs or sets 350. For example, in the illustrative embodiment, the tire pairs 350 of the tractor trailer 300 includes a left-front pair 352 of tires including a left-front-outer tire (LFO) and a left-front-inner tire (LFI), a right-front pair 354 of tires including a right-front-outer tire (RFO) and a right-front-inner tire (RFI), a left-rear pair 356 of tires including a left-rear-outer tire (LRO) and a left-rear-inner tire (LRI), and a right-rear pair 358 of tires including a right-rear-outer tire (RRO) and a right rear inner tire (RRI). Of course, in other embodiments each set of tires 350 may include more than two tires.

As discussed above, a tire RPM sensor 150 is coupled to each tire of the tire pairs 350 to measure an operational characteristic of each corresponding tire (LFO, LFI, RFI, RFO, LRO, LRI, RRI, and RRO) and produce the tire RPM sensor data indicative of a number of rotations of the associated tire. Additionally, in the illustrative embodiment, the telematics device 106 may be mounted or installed in a cab 302 of the tractor trailer 300, while the telematics gateway 102 is mounted on or installed in a trailer 304 of the tractor trailer 300.

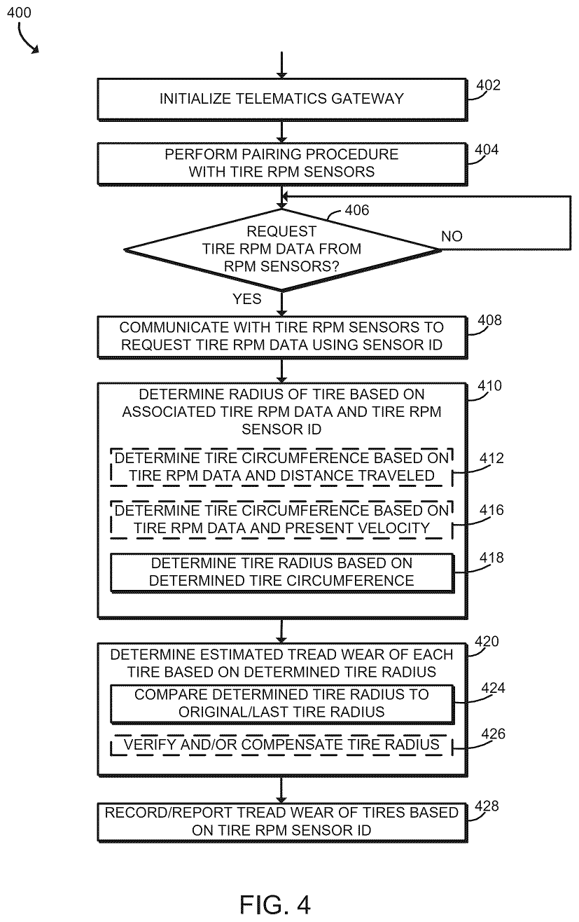

Referring now to FIG. 4, in use, the telematics gateway 102 is configured to execute a method 400 for monitoring tire tread wear of a tire of a wheel of a vehicle. The method 400 begins with block 402 in which the telematics gateway 102 is initialized. For example, the telematics gateway 102 may perform certain validity checks, establish communications with the telematics device 106, and/or perform other initialization procedures. After the telematics gateway 102 has been initialized in block 402, the method 400 advances to block 404 in which the telematics gateway 102 performs a pairing procedure with each tire RPM sensor 150. In doing so, the telematics gateway 102 is provided with identification data of each tire RPM sensor 150, which allows the telematics gateway 102 to directly communicate with each tire RPM sensor 150.

After the telematics gateway 102 has been paired with each tire RPM sensor 150 in block 406, the method 400 advances to block 408 in which the telematics gateway 106 determines whether to request tire RPM data from one or more tire RPM sensors 150. If so, the method 400 advances to block 408 in which the telematics gateway 102 communicates with one or more tire RPM sensors 150 to request the tire RPM data from that particular sensor. In doing so, the telematics gateway 102 may communicate with the desired tire RPM sensor 150 using the sensor identification data received from that tire RPM sensor 150 during the pairing procedure of block 404.

After the telematics gateway 102 has received the tire RPM data from the one or more tire RPM sensors 150 in block 408, the telematics gateway 102 determines the radius of the respective tire(s) based on the received tire RPM data and the sensor identification data of the reporting tire RPM sensor 150. To do so, in some embodiments, the telematics gateway 102 may determine the tire circumference of the respective tire based on the received tire RPM data and a distance traveled by the associated vehicle in block 412.

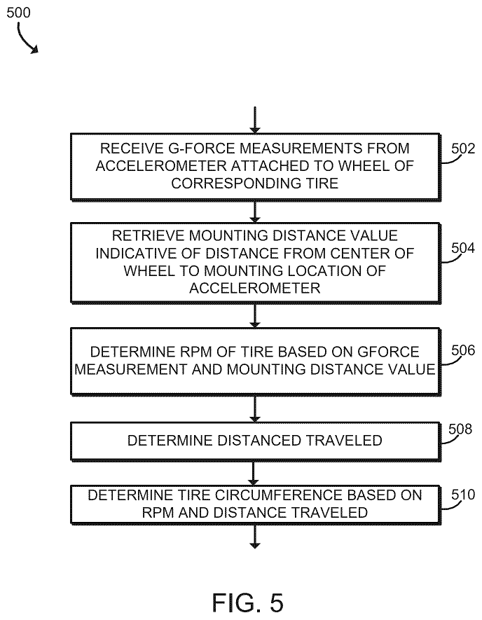

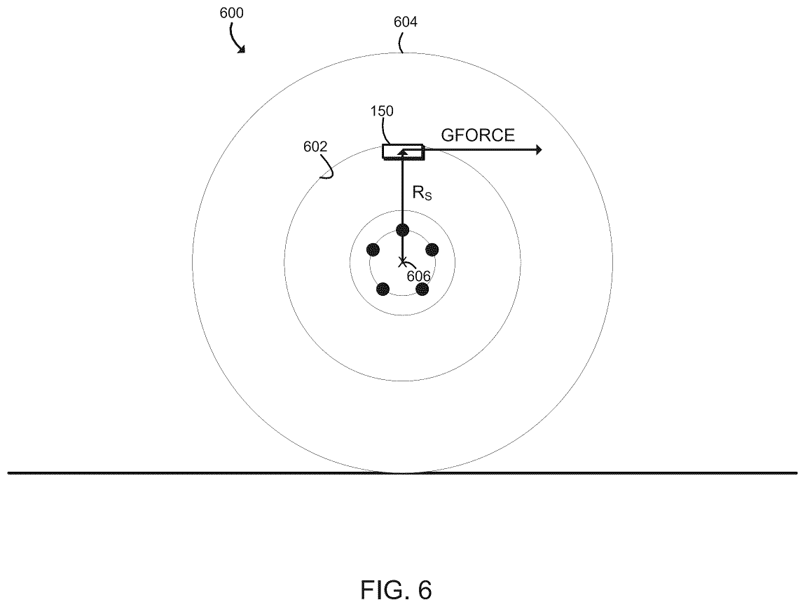

The telematics gateway 102 may determine the tire circumference of the respective tire based on the received tire RPM data and a distance traveled using one of several different methodologies based on the particular type of tire RPM sensor 150 used in the present embodiment. For example, in embodiments in which the tire RPM sensor 150 is embodied as an accelerometer sensor configured to generate g-force measurements indicative of a linear acceleration of the associated tire, the telematics gateway 102 may execute a method 500 to determine the tire circumference as shown in FIG. 5. The method 500 begins with block 502 in which the telematics gateway 102 receives g-force measurements from the accelerometer sensor 150, which is attached to a rim of the wheel of the associated tire. In block 504, the telematics gateway 150 receives a mounting distance value that is indicative of a distance from a center of the associated wheel to the mounting location of the accelerometer sensor 150. That is, as shown in FIG. 6, the accelerometer sensor 150 may be mounted to a rim 602 of a wheel 600 to facilitate the measurement of tire tread wear of a tire 604 of the wheel 600. The accelerometer sensor 150 is mounted a distance, Rs, from the center 606 of the rim 602. The distance, Rs, may be standardized or predefined across all wheels 600 of the vehicle and may be pre-programmed into, stored in, and/or otherwise communicated to the telematics gateway 102. For example, the telematics gateway 102 may store the mounting distance value, Rs, in the data storage 130 and subsequently retrieve that value during the execution of block 504.

Referring back to FIG. 5, after the telematics gateway 102 has retrieved the mounting distance value, Rs, in block 504, the method 500 advances to block 506. In block 506, the telematics gateway 102 determines the revolutions-per-minute (RPM) of the tire based on the g-force measurement received in block 502 and the mounting distance value, Rs, retrieved in block 504. To do so, in an illustrative embodiment, the telematics gateway 102 is configured to determine the tire RPM based on the following ennation.

$${RPM}_{T} = \frac{{G}_{S}}{1.118 \times {10}^{- 5} \times {R}_{S}}$$

wherein RPMT is the revolutions-per-minute (RPM) of the tire, Gs is the g-force measurement received in block 502, and Rs is the mounting distance value retrieved in block 504. Of course, in some embodiments, an average tire RPM is determined in block 506 by determining an average g-force measurement over a reference period of time.

After the telematics gateway 102 has determined the RPM value of the tire in block 506, the method 500 advances to block 508. In block 508, the telematics gateway 102 determines a distance traveled by the associated vehicle. The traveled distance may be determined over a reference period of time (e.g., the same reference period of time over which the average g-force measurement value is determined as discussed above). To do so, the telematics gateway 102 may utilize any suitable methodology to determine the traveled distance such as mounting an odometer of the associated vehicle or determining the traveled distance based on GPS measurement or the like. Regardless, in block 510, the telematics gateway 102 determines the tire circumference based on the tire RPM determined in block 506 and the distance traveled in block 508. To do so, in an illustrative embodiment, the telematics gateway 102 is configured to determine the tire circumference using the following equation:

$${C}_{T} = \frac{R P {M}_{T}}{DIST}$$

wherein CT is the determined circumference of the associated tire, RPMT is the revolutions-per-minute (RPM) of the associated tire, and DIST is the distance traveled over the reference time period.

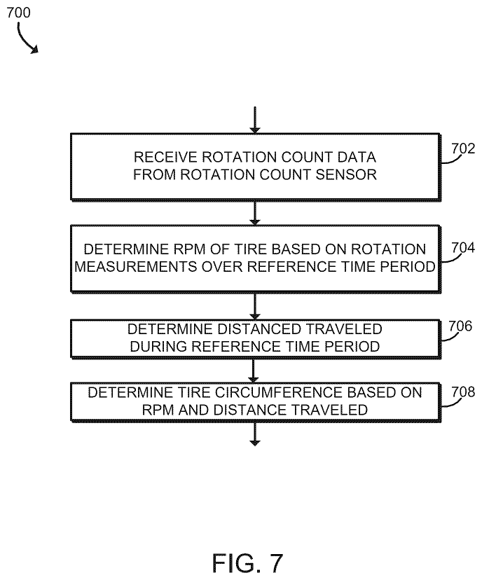

Again, the telematics gateway 102 may utilize different methodologies to determine the tire circumference of the respective tire based on the particular type of tire RPM sensor 150. For example, in embodiments in which the tire RPM sensor 150 is embodied as a rotation count sensor configured to directly measure or detect each rotation of the associated tire, the telematics gateway 102 may execute a method 700 to determine the tire circumference as shown in FIG. 7. The method 700 begins with block 702 in which the telematics gateway 102 receives rotation count data from the rotation count sensor 150. The rotation count data is indicative of a number of full rotations of the associated tire and may be measured or monitored over a reference time period to determine a final rotation count for that reference time period. In block 704, the telematics gateway 102 coverts the rotation count to a revolutions-per-minute (RPM) of the associated tire, which is simply the number of counted rotations of the tire over the observation period (i.e., the reference time period).

After the telematics gateway 102 has determined the RPM value of the tire in block 704, the method 700 advances to block 706 in which the telematics gateway 102 determines a distance traveled by the associated vehicle. Again, the traveled distance may be determined over a reference period of time (e.g., the same reference period of time over which the average g-force measurement value is determined as discussed above). To do so, the telematics gateway 102 may utilize any suitable methodology to determine the traveled distance such as mounting an odometer of the associated vehicle or determining the traveled distance based on GPS measurement or the like. Subsequently, in block 708, the telematics gateway 102 determines the tire circumference based on the tire RPM determined in block 704 and the distance traveled determined in block 706. To do so, in an illustrative embodiment, the telematics gateway 102 is configured to determine the tire circumference using the following equation:

$${C}_{T} = \frac{R P {M}_{T}}{DIST}$$

wherein CT is the determined circumference of the associated tire, RPMT is the revolutions-per-minute (RPM) of the associated tire, and DIST is the distance traveled over the reference time period.

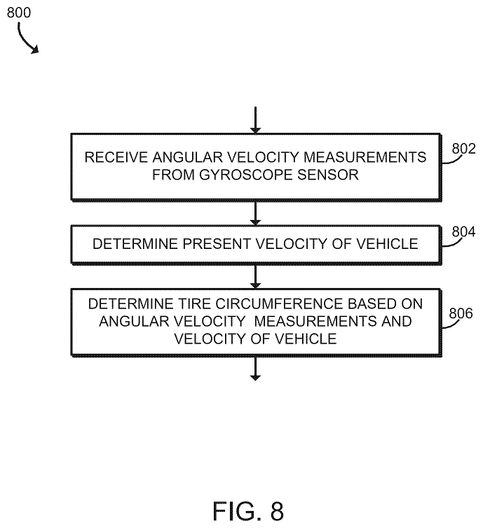

Referring back to block 410 of FIG. 4, in other embodiments, the telematics gateway 102 may be configured to determine the tire circumference of the respective tire based on the received tire RPM data and a present velocity of the associated vehicle in block 416. For example, in embodiments in which the tire RPM sensor 150 is embodied as a gyroscope sensor 150 configured to generate angular velocity data indicative of a present angular velocity of the associated tire, the telematics gateway 102 may execute a method 800 to determine the tire circumference as shown in FIG. 8. The method 800 begins with block 802 in which the telematics gateway 102 receives present angular velocity measurements from gyroscope sensor 150. In block 804, the telematics gateway 102 determines a present velocity of the associated vehicle. To do so, the telematics gateway 102 may determine the present velocity based on velocity data reported by the vehicle itself, by monitoring GPS data over time, or the like. Subsequently, in block 806, the telematics gateway 102 determines the tire circumference using the following equation:

$${C}_{T} = \frac{{V}_{v}}{( A {V}_{T} \div 360 )}$$

Wherein CT is the determined circumference of the associated tire, V_{V} is the present velocity of the vehicle, ΔV_{T} is the present angular velocity of the associated tire, and 360 is a degree value to convert the angular velocity to rotations-per-second. In this way, the telematics gateway 102 may determine an “instantaneous” tire circumference of the associated tire.

Referring now back to FIG. 4, after the telematics gateway 102 has determined the tire circumference in blocks 412 or 416, the telematics gateway 102 determines the tire radius based on the determined tire circumference in block 418. To do so, the telematics gateway 102 may divided the determined circumference by 2π. Subsequently, in block 420, the telematics gateway determines an estimated tread wear of each tire based o the associated determined tire radii. To do so, in some embodiments, the telematics gateway 102 may compare the determined tire radius to an original or previously determined tire radius to identify an amount of difference in the tire radius, which is indicative of an amount of tire tread wear of that particular tire.

In some embodiments, in block 426, the telematics gateway 102 may be configured to verify and/or compensate the determined tire radius based on one or more various factors. For example, the determined radius may be adjusted based on a present load of the vehicle, a distance traveled of the vehicle, a time length since the tire was last maintained, a present tire pressure of the associated tire, and/or other criteria or characteristic associated with the tire and/or the vehicle to which the tire is associated. Regardless, in block 428, the telematics gateway 102 records and/or report the determined tire tread wear to the telematics device 106. In doing so, the reported tire tread wear may be associated with each particular tire based on the identification data of the tire RPM sensor 150.

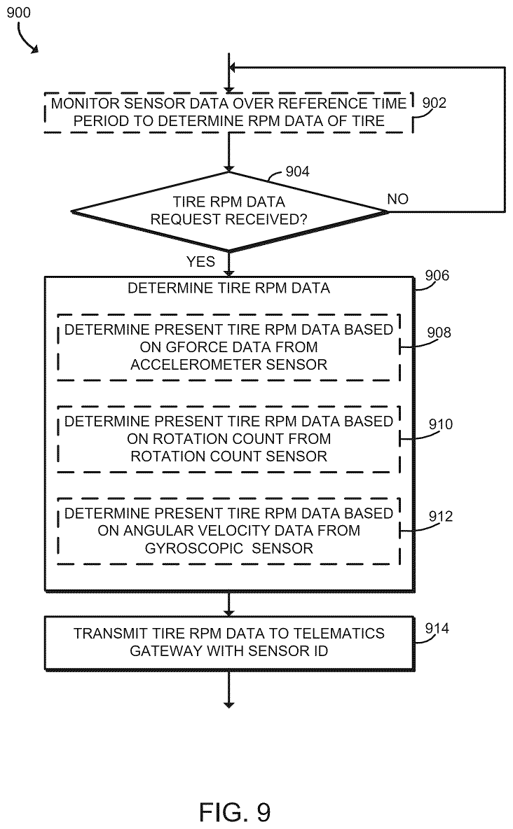

Referring now to FIG. 9, in use, each tire RPM sensor 150 is configured to execute a method 900 for determining tire RPM data. The method 900 begins with block 902 in which the tire RPM sensor 150 monitor sensor data generated by the associated tire revolution sensor 220 (e.g., the accelerometer sensor 222, the rotation count sensor 224, or the gyroscope sensor 226). In block 904, the tire RPM sensor 150 determines whether a request for tire RPM data has been received from the telematics gateway 102. To do so, the tire RPM sensor 150 may monitor for requests using the identification data associated with that particular tire RPM sensor 150.

If the tire RPM sensor 150 determines that a valid request for tire RPM data has been received from the telematics gateway 102 in block 904, the method 900 advances to block 906. In block 906, the tire RPM sensor 150 determines the relevant tire RPM data. For example, in embodiments in which the tire RPM sensor 150 includes an accelerometer sensor 222, the tire RPM sensor 150 may determine the present tire RPM data based on the g-force sensor data generated by the accelerometer sensor 222 in block 908. Alternatively, in embodiments in which the tire RPM sensor 150 includes a rotation count sensor 224, the tire RPM sensor 150 may determine the present tire RPM data based on the rotation count data generated by the rotation count sensor 224 in block 910. Further, in embodiments in which the tire RPM sensor 150 includes a gyroscope sensor 226, the tire RPM sensor 150 may determine the present tire RPM data based on the angular velocity data generated by the gyroscope sensor 226 in block 912. Regardless, in block 914, the tire RPM sensor 150 is configured to transmit the determined tire RPM data to the telematics gateway 102. In doing so, the tire RPM sensor 150 may transmit the determined tire RPM data using the sensor identification data associated with that particular tire RPM sensor 150. In this way, the tire RPM sensor 150 monitors and reports tire RPM data of the associated tire, which is indicative of a number of rotations of that associated tire as discussed above.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A telematics system for monitoring tire tread wear of a tire of a wheel of a vehicle, the telematics system comprising:
a tire revolutions-per-minute (RPM) sensor coupled to the wheel of the vehicle, wherein the tire RPM sensor is configured to generate tire RPM data that is indicative of a number of rotations of the tire; and
a telematics gateway configured to communicate with the tire RPM sensor to request the tire RPM data, determine a radius of the tire based on the tire RPM data, and determine an estimated amount of tire tread wear of the tire based on the determined radius of the tire.

2. The telematics system of claim 1, wherein the tire RPM sensor is an accelerometer sensor and the tire RPM data is g-force sensor data indicative of an acceleration of the vehicle.

3. The telematics system of claim 2, wherein the accelerometer is mounted on the wheel a mounting distance from a center of the wheel, and
wherein to determine the radius of the tire based on the tire RPM data comprises to determine the radius of the tire based on the g-force sensor data and the mounting distance.

4. The telematics system of claim 3, wherein to determine the radius of the tire based on the g-force sensor data and the mounting distance comprises to determine a revolutions-per-minute (RPM) of the tire based on the g-force sensor data and the mounting distance.

5. The telematics system of claim 4, wherein to determine the radius of the tire based on the tire RPM data comprises to:
determine a distance traveled by the vehicle over a reference time period;
determine an average RPM of the tire over the reference time period based on the g-force sensor data and the mounting distance;
determine a tire circumference of the tire based on the distance traveled and the average RPM of the tire; and
determine the radius of the tire based on the determined tire circumference.

6. The telematics system of claim 1, wherein the tire RPM sensor is a rotation count sensor and the tire RPM data is rotation count sensor data indicative of a number of rotations of the tire over a reference time period.

7. The telematics system of claim 6, wherein to determine the radius of the tire based on the tire RPM data comprises to:
determine a distance traveled by the vehicle over the reference time period;
determine a tire circumference of the tire based on the distance traveled and the rotation count sensor data; and
determine the radius of the tire based on the determined tire circumference.

8. The telematics system of claim 1, wherein the tire RPM sensor is a gyroscope sensor and the tire RPM data is angular velocity data indicative of a present angular velocity of the tire.

9. The telematics system of claim 8, wherein to determine the radius of the tire based on the tire RPM data comprises to:
determine a present velocity of the vehicle;
determine a tire circumference of the tire based on the present velocity and the angular velocity; and
determine the radius of the tire based on the determined tire circumference.

10. The telematics system of claim 1, wherein to determine the estimated amount of tire tread wear of the tire based on the determined radius of the tire comprises to compare the determined radius of the tire to a previously determined radius of the tire.

11. A method for monitoring tire tread wear of a tire of a wheel of a vehicle, the method comprising:
communicating, by a telematics gateway, with a tire RPM sensor coupled to the tire of the wheel of the vehicle to request tire RPM data, wherein the tire RPM data is indicative of a number of rotations of the tire;
determining, by the telematics gateway, a radius of the tire based on the tire RPM data; and
determining, by the telematics gateway, an estimated amount of tire tread wear of the tire based on the determined radius of the tire.

12. The method system of claim 11, wherein:
communicating with the tire RPM sensor comprises communicating, by the telematics gateway, with an accelerometer sensor mounted on the wheel a mounting distance from a center of the wheel to request g-force sensor data from the accelerometer, and
determining the radius of the tire based on the tire RPM data comprises determining, by the telematics gateway, a revolutions-per-minute (RPM) of the tire based on the g-force sensor data and the mounting distance.

13. The method of claim 12, wherein determining the radius of the tire based on the tire RPM data comprises:
determining, by the telematics gateway, a distance traveled by the vehicle over a reference time period;
determining, by the telematics gateway, an average RPM of the tire over the reference time period based on the g-force sensor data and the mounting distance;
determining, by the telematics gateway, a tire circumference of the tire based on the distance traveled and the average RPM of the tire; and
determining, by the telematics gateway, the radius of the tire based on the determined tire circumference.

14. The method of claim 11, wherein communicating with the tire RPM sensor comprises communicating, by the telematics gateway, with a rotation count sensor to request rotation count sensor data indicative of a number of rotations of the tire over a reference time period.

15. The method of claim 14, wherein determining the radius of the tire based on the tire RPM data comprises:
determining, by the telematics gateway, a distance traveled by the vehicle over the reference time period;
determining, by the telematics gateway, a tire circumference of the tire based on the distance traveled and the rotation count sensor data; and
determining, by the telematics gateway, the radius of the tire based on the determined tire circumference.

16. The method of claim 11, wherein communicating with the tire RPM sensor comprises communicating, by the telematics gateway, with a gyroscope sensor to request angular velocity data indicative of a present angular velocity of the tire.

17. The method of claim 16, wherein determining the radius of the tire based on the tire RPM data comprises:
determining, by the telematics gateway, a present velocity of the vehicle;
determining, by the telematics gateway, a tire circumference of the tire based on the present velocity and the angular velocity; and
deter determining, by the telematics gateway, mine the radius of the tire based on the determined tire circumference.

18. The method of claim 11, wherein determining the estimated amount of tire tread wear of the tire based on the determined radius of the tire comprises comparing, by the telematics gateway, the determined radius of the tire to a previously determined radius of the tire.

19. One or more non-transitory, computer-readable storage media comprising a plurality of instructions that in response to being executed cause a telematics gateway to:
communicate with a tire RPM sensor coupled to the tire of the wheel of the vehicle to request tire RPM data, wherein the tire RPM data is indicative of a number of rotations of the tire;
determine a circumference of the tire based on the tire RPM data;
determine a radius of the tire based on the determined circumference of the tire; and
determine an estimated amount of tire tread wear of the tire based on the determined radius of the tire.

20. The one or more non-transitory, computer-readable storage media of claim 19, wherein to determine the estimated amount of tire tread wear of the tire based on the determined radius of the tire comprises to compare the determined radius of the tire to a previously determined radius of the tire.
